(19) United States
(12) Patent Application Publication
(10) Pub. No.: US 2026/0317211 A1
(43) Pub. Date: Oct. 15, 2026

(54) METHOD FOR LIQUID-SOLID SEPARATION

(71) Applicant: Kemira Oyj, Helsinki (FI)

(72) Inventors: Jonni AHLGREN, Espoo (FI); Michael RECKTENWALD, Espoo (FI); Jouni TOURONEN, Espoo (FI); Jussi NIKKARINEN, Espoo (FI)

(21) Appl. No.: 19/113,650

(22) PCT Filed: Sep. 19, 2023
(86) PCT No.: PCT/FI2023/050531

§ 371 Date: Mar. 20, 2025

(30) Foreign Application Priority Data
Sep. 20, 2022 (FI) 20225813

(51) Int. Cl. C02F 1/56; C02F 11/147; C02F 103/34

(52) U.S. Cl. CPC C02F 1/56; C02F 11/147; C02F 2103/34

(57) ABSTRACT

The invention relates to a method for flocculating solid particles in a liquid-solid separation process. The method comprises obtaining of a suspension of solid particles suspended in a continuous aqueous phase and obtaining a flocculant solution comprising cationized starch having an original charge density <3 meq/g. The flocculant solution is subjected to a high shear treatment, and after the high shear treatment the flocculant solution is brought into a contact with the suspension of solid particles and the solid particles are flocculated. The flocculated solid particles are separated from the continuous aqueous phase in a dewatering step.

The present invention relates to a method for flocculating solid particles in liquid-solid separation process according to the preamble of the enclosed independent claim.

Many industrial processes comprise a liquid-solid separation step, where solid particles are separated from a liquid phase. Usually a suspension of solid material suspended in an aqueous continuous phase is subjected to the liquid-solid separation for providing a solid fraction and a liquid fraction that can be separately processed further. For example, liquid-solid separation steps are employed in water treatment processes, in manufacture of pulp, paper, board or the like, as well as in mining industry. One typical example of a liquid-solid separation step is sludge dewatering in any water treatment process. The sludge usually comprises various solid particles and/or microorganisms suspended in an aqueous phase. In a liquid-solid separation step the water content of the sludge is reduced so that the solid fraction of the sludge can be processed further, for example deposited, used as a fertilizer, or incinerated for energy production.

Often liquid-solid separation step includes flocculation of the solid particles suspended in a liquid phase. Flocculating and/or coagulating chemicals are used to improve the formation and/or the quality of the formed flocs. For example, in a water treatment process the sludge may be conditioned before the dewatering step by addition of flocculating agents, such as inorganic compounds of iron and lime, or synthetic organic polymers. These flocculating agents are added to the sludge in order to improve the sludge handling and to increase the dewatering effect in the liquid-solid separation.

Cationic polymers are conventionally used as flocculants in liquid-solid separation. Cationic polymers used as flocculants are usually petroleum-based synthetic polymers. Due to the non-degradable nature of the synthetic polymers, it may become impossible to use the separated solid fraction obtained from waste water treatment for landfills, composting, or for soil improvement, when synthetic cationic polymers have been employed in the liquid-solid separation step. Furthermore, there is a current growing incentive towards more sustainable industrial processes and towards bio-based and/or biodegradable chemicals. This desire to use bio-based and/or biodegradable chemicals has induced a strong interest to find replacements for petroleum-based synthetic cationic polymers. Also the increasing price of petroleum has reduced its attractivity as a raw material.

In general, many biobased cationic polymers have not been able to provide the same efficiency as the synthetic polymers, or the biobased polymers require extensive processing, e.g. high cationization and/or derivatizing, in order to show proper effect as flocculant in liquid-solid separation process. This naturally reduces the performance or increases the cost involved. Consequently, there is a need for alternative ways to obtain appropriate results in liquid-solid separation by using biobased material as flocculant.

An object of this invention is to minimise or even eliminate the disadvantages existing in the prior art.

An object is also to provide more a sustainable method for flocculation in a liquid-solid separation process, especially for sludge dewatering in a water treatment process.

A further object of the invention is to provide a method which provides an effective flocculation and a high solids content for the separated solids after the liquid-solid separation step.

These objects are attained with the invention having the characteristics presented below in the characterising part of the independent claim. Some preferable embodiments are disclosed in the dependent claims.

The embodiments mentioned in this text relate, where applicable, to all aspects of the invention, even if this is not always separately mentioned.

Typical method according to the present invention for flocculating solid particles in a liquid-solid separation process comprises
obtaining a flocculant solution comprising cationized starch having an original charge density <3 meq/g;
subjecting the flocculant solution to a high shear treatment;
after the high shear treatment bringing the flocculant solution into a contact with a suspension of solid particles suspended in a continuous aqueous phase and flocculating the solid particles; and
separating the flocculated solid particles from the continuous aqueous phase in a dewatering step.

Now it has been surprisingly found that when a solution of cationized starch having an original charge density of <3 meq/g, measured at pH 4, is subjected to an appropriate high shear treatment, the cationicity of the starch is increased by the high shear treatment and the flocculating ability of the cationized starch is improved in unexpected manner without any other chemical treatment. The cationicity increase caused by the high shear treatment may be even up to two- or threefold of the original cationicity. This unanticipated increase in cationicity and in flocculating ability of the cationized starch may be manifested by a high solid content after liquid-solid separation, short dewatering time and/or improved floc properties, e.g. floc strength, providing in general more effective liquid-solid separation. The theoretical background of the observed phenomenon is not yet fully understood, but it is assumed that the high shear treatment has an impact on the structure of the cationized starch, providing more cationic groups for interaction with the solid particles during flocculation.

According to one embodiment of the present invention the flocculant solution comprising dissolved cationized starch is subjected to a high shear treatment where a shear power of at least 5 W/kg, preferably at least 20 W/kg, more preferably at least 35 W/kg, is applied on the flocculant solution comprising or consisting of cationized starch. The high shear treatment is thus an integral feature of the present invention. According to one preferable embodiment the flocculant solution may be subjected in the high treatment to the shear power which is in a range of 5-10 000 W/kg, preferably 20-5000 W/kg, more preferably 35-1000 W/kg, even more preferably 35-300 W/kg or 35-209 W/kg. Sometimes the shear power may be up to 500 W/kg. The duration of the high shear treatment may preferably be at most 600 s, preferably 1-600 s, more preferably of 5-300 s, even more preferably of 10-180 s or 30-150 s. In general, the higher the power used in the high shear treatment, the shorter the duration of the high shear treatment may be and vice versa.

The flocculant solution may preferably be subjected to the high shear treatment in absence of oxidative agent(s). This means that the high shear treatment of the flocculant solution comprising dissolved cationized starch is preferably conducted in absence of oxidative agent(s), such as hydrogen peroxide. In this manner it is possible to reduce the risk for shortening or degrading of cationic starch molecules.

The concentration of cationized starch in the flocculant solution during the high shear treatment may be 0.05-2 weight-%.

According to another embodiment, the flocculant solution comprising cationized starch may be subjected to a high shear treatment that provides a temperature increase of 5-15° C. for the flocculant solution without external heating.

The turbidity of the flocculant solution comprising dissolved cationized starch may be ≤100 NTU, preferably ≤50 NTU, for example 1-100 NTU or 5-50 NTU. The low turbidity of the flocculant solution, i.e. its transparency, both before and after the high shear treatment, indicates the presence of cationized starch as fully dissolved form.

The high shear treatment is preferably conducted as continuous in-line treatment. This means that the duration of the high shear treatment is preferably at most 60 s. In some embodiments, the duration of the high shear treatment may be 1-60 s, preferably 3-45 s, more preferably 5-30 s. The duration of the high shear treatment may be relatively short, as the cationized starch in the flocculant solution is already in dissolved form when it is subjected to the high shear treatment. Thus the high shear treatment is not used for dissolving the cationized starch, but to improve its capability as flocculant. The short duration of the high shear treatment makes the invention especially suitable for industrial usage.

The flocculant solution comprising dissolved cationized starch is preferably subjected to high shear treatment once or subjected to two, three or four successive high shear treatments. Preferably, the flocculant solution is subjected to high shear treatment one time. It is highly surprising that subjecting the cationized starch to high shear treatment only one time or few successive times is already able to produce such a pronounced effect in the flocculating ability. The limited duration to the high shear treatment also maintains the molecular length of the cationized starch and reduces the risk of significant breaking the starch molecules.

The flocculant solution comprising, or consisting of, dissolved cationized starch may be subjected to the high shear treatment in any suitable high-shear apparatus or high-shear device, which is able to create appropriate high shear power in aqueous systems. The high shear treatment is preferably carried out or conducted in or under unpressurised conditions, i.e. by using mixing apparatuses or homogenizer where no premediated overpressure is created within the mixing apparatus or homogenizer. For example, the flocculant solution comprising dissolved cationized starch may be subjected to the high shear treatment in a homogenizer, a high-speed mixer, a disperser, a rotor-stator mixer, a mixer with two counterrotating rotors, centrifugal pumping device providing a straight flow or back rotation flow, high pressure devices, shear pumps or the like. In some cases also ultrasonic treatment is applicable as high shear treatment. Suitable high shear mixing apparatuses and homogenizers are well-known for a person skilled in the art and commercially available, for example under tradenames Ultra Turrax®, Polytron®, Atrex®, Silverson®, Ystral®, Cavitron™ and Waukesha Shear Pumps™. For example, the cationized starch may be dissolved in water, subjected to the high shear treatment by high-shear homogenisation and then brought into contact with the aqueous suspension comprising solid particles to be flocculated. The high-shear homogenisation may be achieved, for example, by using rotational speed of at least 2000 rpm. The homogenisation is preferably performed as mechanical homogenisation without using pressure differences, for example in a homogenizer using rotor-stator principle. The appropriate shear power may be achieved alternatively in a high shear treatment where the dissolved cationized starch is subjected to the high shear power by centrifugal pumps or the like, e.g. during pumping of the cationized starch after it has been dissolved in water.

The cationized starch used in the present invention is in form of an aqueous solution, which means that the cationic starch is dissolved in water before the high-shear step.

The cationized starch, which is suitable for use as a flocculant after it has been dissolved in water and subjected to high shear treatment, has the original charge density <3 meq/g, preferably in the range of 1.2-2.7 meq/g, more preferably 1.5-2.5 meq/g, even more preferably 1.6-2.0 meq/g, measured at pH 4 before the high shear treatment. The charge density was determined as described in the experimental part. It was unexpectedly found that the cationicity and the flocculation effectivity of the cationized starch was especially enhanced when the cationicity of the cationized starch before the high shear treatment was within the described range. The charge density of the cationized starch may be increased by the high shear treatment 1.3-2.5 times or 1.5-2.5 times from the original charge density. For example, charge density of the cationized starch may be increased by the high shear treatment 0.2-1.4 meq/g, preferably 0.4-1.0 meq/g, more preferably 0.5-0.7 meq/g, from the original charge density, which is the charge density measured before the high shear treatment. If the cationicity of the dissolved cationized starch was higher than 3 meq/g, the high shear treatment did not provide desired improvement in cationicity or flocculating ability of the cationized starch. The invention thus provides a possibility to increase the cationicity of the starch without increasing the use of cationization chemicals.

Starch used in the present invention may be cationized by any suitable method. Preferably starch is cationized by using 2,3-epoxypropyltrimethylammonium chloride or 3-chloro-2-hydroxypropyltrimethylammonium chloride, 2,3-epoxypropyltrimethylammonium chloride being preferred. It is also possible to provide cationized starch by using other applicable cationization methods, e.g, methods providing quaternary ammonium esters of starch.

The cationized starch may have a substitution degree in a range of 0.32-0.65, preferably 0.33-0.60, more preferably 0.34-0.55.

The cationized starch may be made of any natural starch, such as potato starch, tapioca starch, corn starch, waxy corn starch, waxy potato starch, wheat starch, barley starch, rice starch, waxy rice starch, pea starch, legume starch or any of their mixtures.

The flocculant solution comprising cationized starch may be obtained by dissolving or solubilizing the cationized starch into water. The dissolving or solubilization of cationized starch can be done by any suitable method known as such for a person skilled in the art. The cationized starch used in the present invention are usually directly soluble in water at room temperature (25° C.), typically without cooking procedures or the like. The cationized starch is thus dissolved into water and forms an aqueous flocculant solution. The flocculant solution is preferably free of starch granules or starch particles. The dissolving of cationized starch in water is preferably done without the use of elevated temperature over 40° C., preferably over 30° C., i.e. without any cooking procedures involving elevated temperature and/or pressure.

The flocculant solution preferably comprises alkaline earth metal ions, especially Ca, in amount of <1.5 g/l, more preferably <1 g/l. The amount of alkaline earth metal ions may be from 0 g/l to less than 1.5 g/l or less than 1 g/l. The flocculant solution preferably comprises halogen salts, especially chloride, in amount of <2 g/l, more preferably <1 g/l. The amount of halogen salts may be from 0 g/l to less than 2 g/l or less than 1 g/l.

The cationized starch solution used as a flocculant solution may have a 3% salt viscosity of at least 3 mPas, preferably at least 5 mPas, more preferably at least 10 mPas, when measured before the high shear treatment. The 3% salt viscosity may be, for example, in a range of 3-10 000 mPas, preferably 5-7000 mPas, more preferably 10-4000 mPas. The measurement of 3% salt viscosity is determined as defined in the experimental part of this application.

According to one preferable embodiment the used cationized starch is non-degraded starch. In the present context the term “non-degraded starch” denotes cationized starch which is essentially untreated by oxidative, thermal, enzymatical and/or acid treatment in a manner that would cause hydrolysis of glycosidic bonds or degradation of starch molecules or units. It is assumed that use of non-degraded starch provides appropriate size or length for starch molecules, beneficial for flocculation.

Furthermore, the used cationized starch is preferably non-crosslinked cationized starch. As the length or size of the dissolved cationized starch molecules are essentially maintained even after the high shear treatment, no crosslinking of starch is required.

According to one embodiment, the method for flocculating solid particles in a liquid-solid separation process may comprise
obtaining a suspension of solid particles suspended in a continuous aqueous phase;
obtaining a flocculant solution comprising cationized starch having an original charge density <3 meq/g;
subjecting the flocculant solution to a high shear treatment;
after the high shear treatment bringing the flocculant solution into a contact with the suspension of solid particles and flocculating the solid particles; and
separating the flocculated solid particles from the continuous aqueous phase in a dewatering step.

According to one embodiment of the invention the flocculant solution may comprise, in addition to dissolved cationized starch, one or more cationic synthetic polymers, preferably cationic polyacrylamide. The flocculant solution may comprise 10-100 weight-%, preferably 30-100 weight-%, more preferably 50-99 weight-%, of cationized starch, calculated from the active polymer content of the flocculant solution. Use of cationic polymer together with cationized starch increases the flocculation effectivity of the flocculant solution, especially in demanding applications, while still providing a more sustainable alternative in comparison to conventional synthetic polymer flocculants.

It is also possible that an additional flocculating agent is brought into contact with the suspension of solid particles separately from the flocculant solution comprising cationized starch. The additional flocculating agent may be brought into contact with the suspension of solid particles simultaneously with the flocculant solution, or before or after the flocculant solution is brought into contact with the suspension of solid particles. The additional flocculating agent may be inorganic or organic flocculating agent. According to one embodiment the additional flocculating agent is cationic synthetic polymer, such as cationic polyacrylamide.

The present invention is suitable for flocculating solid particles in any liquid-solid separation process where solid particles are separated from an aqueous liquid phase. Preferably, the liquid-solid separation process is a treatment process of wastewater, preferably municipal wastewater or industrial wastewater. For example, the present invention is especially suitable for liquid-solid separation process selected from wastewater treatment, sludge dewatering or for conditioning drinking water.

According to one preferable embodiment the liquid-solid separation process may be a sludge dewatering step of a water treatment process, for example, sludge dewatering step of a municipal wastewater treatment process or sludge dewatering step of an industrial wastewater treatment process. Sludge is here understood as an aqueous suspension, which comprise a continuous aqueous liquid phase and organic and/or inorganic solid material and/or particles suspended in the aqueous liquid phase. The sludge, i.e. the aqueous suspension, to be dewatered may be municipal wastewater sludge or agricultural sludge, or it may originate from a biological treatment process of wastewater and/or from a biological treatment process of sewage. Alternatively, the aqueous suspension, i.e. sludge, may originate from an industrial process, especially from wastewater treatment of an industrial process, or from food or beverage production or from food or beverage processing.

The aqueous suspension to be treated with the flocculant solution according to the invention thus usually comprises a continuous aqueous liquid phase and organic and/or inorganic solid material and/or particles suspended in the aqueous liquid phase. The suspension may be rich in material of bacterial origin, especially if it originates from a water treatment process. The aqueous liquid phase of the suspension may contain also dissolved organic substances, such as polysaccharides, humic substances and fatty acids. The suspension may have a biological oxygen demand (BOD)>50 mg/l, chemical oxygen demand (COD) in a range of 15-45 g/l, preferably 20-40 g/l, and/or a dry solids content in a range of 5-80 g/l, preferably 10-60 g/l, more preferably 20-55 g/l. pH of the suspension may be in a range from pH 6 to pH 9, preferably from pH 7 to pH 8. The conductivity of the suspension may be in a range of 5-14 mS/cm, preferably 5-10 mS/cm, and/or the charge density may be in a range from −5.5 to −1.5 μeq/g, preferably from −5.0 to −1.8 μeq/g. Total phosphorous value for the suspension may be in a range of 400-1400 mg/l, preferably 450-1200 mg/l and/or the total nitrogen value in a range of 1.2-3.5 g/l, preferably 1.5-3.0 g/l.

If the present invention is used in wastewater treatment process, especially in a sludge dewatering step, the flocculant solution comprising dissolved cationized starch may be brought into a contact with the suspension in amount of 1-30 kg of cationized starch/ton dry suspension, preferably 2-20 kg of cationized starch/ton dry suspension, more preferably 3-15 kg of cationized starch/ton dry suspension.

### EXPERIMENTAL

Some embodiments of the present invention are described in the following non-limiting examples.

### Cationized Starch and its Characterization

The cationized starch used in the examples was prepared by using 2,3-epoxypropyl-trimethyl-ammonium chloride as cationization reagent.

The cationized starch solutions used in the examples were prepared by dissolving the cationized starch into deionized water. The prepared cationized starch solutions were characterized by measuring their charge density at pH 4, salt viscosity and conductivity as described below. Charge density of the cationized starch solution was measured both before and after the high shear treatment. Other measurements were performed only before the high shear treatment.

### Charge Density

Charge density at pH 4 was determined using BTG's Mütek PCD-04 particle charge titrator. Cationized starch sample was dissolved as 0.20 weight-% solution in deionized water and then diluted to 0.01-0.04 weight-% solution for measurement, depending on charge density of the sample. pH was adjusted to 4.0 with 0.1 M acetic acid and titrated using 0.001 N sodium polyethylenesulfonate (PES-Na) solution as the titrant. During titration pH was normally increasing 0.1-0.3 pH units. Charge density is expressed as meq/g dry substance.

### 3% Salt Viscosity

3% salt viscosity of cationized starch solution in water in presence of salt was determined using Brookfield DV-1 viscometer with a small sample adapter at 25° C., using spindle #18 or #31, depending on viscosity level (called hereafter “3% salt viscosity”). The 3% salt viscosity measurement is performed by using maximum possible rotational speed. LV mode speeds (60, 30, 12, 6, 3, 1.5, 0.6, 0.3 rpm) were normally used, except that as the highest speed used was 100 rpm. The cationized starch was first dissolved in deionized water as 3 weight-% solution. Then sodium chloride (NaCl) in weight ratio NaCl: cationized starch of 5:1 was added and let to dissolve under mixing before the 3% salt viscosity was measured. This means that the 3% salt viscosity of the cationized starch is measured at 2.6 weight-% concentration of cationized starch in an aqueous solution comprising 13.0 weight-% of NaCl. 3% salt viscosity gives a comparable parameter to evaluate the size of the cationized starch molecule.

### Water Viscosity ca. 2% and Salt Viscosity ca. 2%

Water viscosity of cationized starch solution in water was determined using the same equipment and measuring principles as when measuring 3% salt viscosity 3%. For the measurement of water viscosity ca. 2%, the cationized starch sample was first dissolved in deionized water as circa 2 weight-% solution. The cationized starch sample was weighed as such, without taking the moisture content of the cationized starch sample into account. The Brookfield viscosity of this cationized starch solution gave the value for water viscosity ca. 2%. This viscosity was measured both for the cationized starch solution as such and for the same cationized starch solution after the high shear treatment.

Salt viscosity ca. 2% was measured by adding sodium chloride (NaCl) in weight ratio NaCl: weighted cationized starch sample of 5:1 and letting it dissolve under gentle mixing before the viscosity was measured. The Brookfield viscosity of this solution gave value salt viscosity ca. 2%. When high sheared cationized starch samples were used, the salt was added after the high shear treatment.

These water viscosity ca. 2% and salt viscosity ca. 2% measurements were comparative, and they are used to study the impact of the high shear treatment on solution viscosity of the starch solutions. The measurements are comparisons between the same starch solutions after different treatments. Therefore no exact starch concentrations were not required for the measurements. The moisture content of the used starch samples varied in range 0-8 weight-%.

### Conductivity

Conductivity of 0.5 weight-% cationized starch in deionized water was measured using Knick Portavo 902 COND conductivity meter equipped with Knick SE 204 sensor.

### High Shear Treatment

High shear treatment was done by mixing 200 ml of the freshly made 0.2% cationized starch solution using IKA T25 digital Ultra Turrax® homogenizer with blade S 25 N-25 F at 16000 rpm 3 minutes. When high shear treatment was used, the samples are marked with “After UT”.

### Sludge Dewatering Tests

Sludge dewatering tests were carried out by using capillary suction time (CST) test, by using Triton type 319 Multi-purpose CST (Triton Electronics Ltd, UK). Mixing was done with either Heidolph RZR 2021 or IKA RW 20 digital mixer using a 4-blade stirrer with blades total width 30 mm and blade height 15 mm.

In the CST test the mixing speed was 1000 rpm. Cylinder used had diameter 18 mm. The cationized starch sample was added to 100 g of the digested sludge in a 250 ml beaker, and mixed 10 s after addition. After 10 s mixing a 4.5 ml sample was taken to the cylinder and the CST value was measured.

The cationized starch samples for CST testing were first dissolved as 0.5% solutions overnight and then diluted to 0.2% solutions for testing. The solutions were used either as such or after high shear treatment of the solution. High shear treated samples are marked with “After UT”.

### Example 1

Digested sludge was collected from a Finnish wastewater treatment plant. The digested sludge had a dry solids content of 3.0 weigh-% and pH 7.4. Without any chemical additions (zero test) the sludge gave a CST time 354 s.

The properties of the cationized starches (CS) used as flocculant solutions are given in Table 1. Table 1 shows the measured charge densities for the cationized starch without high shear treatment (“No UT”) as well as after the high shear treatment (“After UT”).

CST test results for the cationized starches (CS) used as flocculant solutions are given in Table 2. The cationized starch solution was used as such after dissolution (“No UT”) or after the cationized starch solution was subjected to the high shear treatment (“After UT”).

From the results in Table 1 it can be seen that when the original charge density of the cationized starch (“No UT”) is <3 meq/g, the high shear treatment clearly increases the charge density of the sample (“After UT”). The effect is especially observable when the cationized starch has the charge density in the range of 1.6-2.2 meq/g. From the results in Table 2 it can be seen that the increase in charge density, caused by the high shear treatment, improves the dewatering performance of the cationized starch. This is demonstrated by clearly lower CST values obtained in CST testing at corresponding dosing levels. For the cationized starch CS 5 with the original charge density >3 meq/g, the high shear treatment seems not to improve either the charge density or the dewatering performance.

It can also be seen from Table 1 that the high shear treatment clearly decreases values for water viscosity ca. 2% as well as salt viscosity ca. 2%. In cases where the charge density increase and thus also dewatering performance improvement are the lowest or negligible, the decrease in viscosity is also the lowest or negligible.

TABLE 1
The properties of the cationized starches (CS) used as flocculant solutions.

| | CS 1 | | CS 2 | | CS 3 | | CS 4 | | CS 5 | |
|---|---|---|---|---|---|---|---|---|---|---|
| | No | After | No | After | No | After | No | After | No | After |
| | UT | UT | UT | UT | UT | UT | UT | UT | UT | UT |
| Charge density, | 1.6 | 2.2 | 2.1 | 2.5 | 2.2 | 2.8 | 2.9 | 3.1 | 4.2 | 4.2 |
| meq/g dry | | | | | | | | | | |
| 3% Salt | 459 | | 181 | | 33 | | 24 | | 47 | |
| Viscosity, mPas | | | | | | | | | | |
| Water Viscosity | 8740 | 179 | 820 | 85 | 99 | 40 | 64 | 60 | 226 | 212 |
| ca. 2%, mPas | | | | | | | | | | |
| Salt Viscosity | 79 | 17 | 35 | 12 | 10 | 8.1 | 10 | 9.8 | 15 | 13 |
| ca. 2%, mPas | | | | | | | | | | |
| Conductivity, | 0.59 | | 0.69 | | 0.77 | | 0.84 | | 0.52 | |
| mS/cm | | | | | | | | | | |

TABLE 2
CST test results for the cationized starches (CS) used as flocculant solutions.

| | CST times, s | | | | | | | | | |
|---|---|---|---|---|---|---|---|---|---|---|
| | CS 1 | | CS 2 | | CS 3 | | CS 4 | | CS 5 | |
| Dosage, | No | After | No | After | No | After | No | After | No | After |
| kg/t dry sludge | UT | UT | UT | UT | UT | UT | UT | UT | UT | UT |
| 2 | — | 118 | 173 | 87 | — | 104 | 102 | 98 | 113 | 112 |
| 3 | — | 55 | 131 | 55 | 95 | 68 | 45 | 48 | 69 | 60 |
| 4 | — | 39 | 80 | 26 | 71 | 42 | 25 | 23 | 26 | 28 |
| 6 | 106 | 17 | 48 | 12 | 26 | 15 | 12 | 11 | 12 | 11 |
| 8 | 75 | 15 | 28 | 10 | 18 | 12 | 9.0 | 9.1 | 9.4 | 9.2 |
| 10 | 47 | 12 | 17 | 9.6 | 14 | 10 | 8.4 | 8.8 | 7.9 | 8.5 |

### Example 2

Digested sludge was collected from a Finnish wastewater treatment plant. The digested sludge had a dry solids content of 2.5 weight-% and pH 7.2. Without any chemical additions (zero test) the sludge gave a CST time 242 s.

The properties of the cationized starches (CS) used as flocculant solutions are given in Table 3. Table 3 shows the measured charge densities for the cationized starch without high shear treatment (“No UT”) as well as after the high shear treatment (“After UT”).

CST test results for the cationized starches (CS) used as flocculant solutions are given in Table 4. The cationized starch solution was used as such after dissolution (“No UT”) or after the cationized starch solution was subjected to the high shear treatment (“After UT”).

The results in Tables 1 and 2 confirm the effect of the high shear force treatment. The high shear force treatment increases the charge density of the cationized starch and improves the dewatering performance of the cationized starch.

TABLE 3
The properties of the cationized starches
(CS) used as flocculant solutions.

| | CS 6 | | CS 7 | |
|---|---|---|---|---|
| | No UT | After UT | No UT | After UT |
| Charge density, meq/g | 1.6 | 2.3 | 1.7 | 2.6 |
| 3% Salt Viscosity, | 343 | | 3750 | |
| mPas | | | | |
| Water Viscosity ca. | 4135 | 149 | 41350 | 205 |
| 2%, mPas | | | | |
| Salt Viscosity ca. | 83 | 14 | 219 | 20 |
| 2%, mPas | | | | |
| Conductivity, mS/cm | 0.61 | | 0.69 | |

TABLE 4
CST test results for the cationized starches
(CS) used as flocculant solutions.

| | CST times, s | |
|---|---|---|
| dosage, kg/t | CS 6 | CS 7 |

| dry sludge | No UT | After UT | No UT | After UT |
|---|---|---|---|---|
| 2 | 153 | 90 | 192 | 94 |
| 3 | 120 | 50 | 144 | 46 |
| 4 | 102 | 33 | 125 | 27 |
| 6 | 64 | 16 | 87 | 13 |
| 8 | 36 | 12 | 75 | 9.9 |
| 10 | 29 | 9.3 | 47 | 8.8 |

### Example 3

Digested sludge was collected from a Finnish wastewater treatment plant. The digested sludge had a dry solids content of 2.5 weight-% and pH 7.3. Without any chemical additions (zero test) the sludge gave a CST time 254 s.

The properties of the cationized starches (CS) used as flocculant solutions are given in Table 5. Table 5 shows the measured charge densities for the cationized starch without high shear treatment (“No UT”) as well as after the high shear treatment (“After UT”).

CST test results for the cationized starches (CS) used as flocculant solutions are given in Table 6. The cationized starch solution was used as such after dissolution (“No UT”) or after the cationized starch solution was subjected to the high shear treatment (“After UT”).

The results of Table 5 and 6 further confirm the effect of the high shear force treatment. The high shear force treatment increases the charge density of the cationized starch and improves the dewatering performance of the cationized starch. Especially, as shown in Table 6, when the charge density of the cationized starch is in the range of 0.65-2.0 meq/g, the high shear treatment clearly increases the charge density of the cationized starch. At the same time the high shear treatment improves the dewatering performance of the cationized starch. When the starch density of the cationized starch is close 3 meq/g, the high shear treatment still provides improvement in the dewatering performance, even if no increase in charge density was observed, see results for CS 10.

TABLE 5
The properties of the cationized starches (CS) used as flocculant solutions.

| | CS 8 | | CS 9 | | CS 10 | | CS 11 | |
|---|---|---|---|---|---|---|---|---|
| | No | After | No | After | No | After | No | After |
| | UT | UT | UT | UT | UT | UT | UT | UT |
| Charge density, | 0.65 | 2.0 | 2.0 | 2.4 | 2.8 | 2.8 | 3.0 | 3.2 |
| meq/g dry | | | | | | | | |
| 3% Salt | 4000 | | 436 | | 9.4 | | 19 | |
| Viscosity, mPas | | | | | | | | |
| Water Viscosity | >100000 | >100000 | 7650 | 136 | 16 | 13 | 52 | 45 |
| ca. 2%, mPas | | | | | | | | |
| Salt Viscosity | 10 | 12 | 85 | 16 | 4.8 | 3.8 | 7.5 | 7.7 |
| ca. 2%, mPas | | | | | | | | |
| Conductivity, | 0.96 | | 0.79 | | 0.81 | | 0.81 | |
| mS/cm | | | | | | | | |

TABLE 6
CST test results for the cationized starches
(CS) used as flocculant solutions.

| | CST times, s | | | | | | | |
|---|---|---|---|---|---|---|---|---|
| | CS 8 | | CS 9 | | CS 10 | | CS 11 | |
| dosage, kg/t dry | No | After | No | After | No | After | No | After |
| sludge | UT | UT | UT | UT | UT | UT | UT | UT |
| 2 | — | — | 173 | 91 | 111 | 88 | 75 | 86 |
| 3 | — | — | 136 | 50 | 58 | 48 | 46 | 47 |
| 4 | — | — | 129 | 34 | 43 | 35 | 26 | 27 |
| 6 | — | — | 103 | 15 | 25 | 23 | 13 | 14 |
| 8 | 126 | 89 | 70 | 11 | 22 | 13 | 10 | 11 |
| 10 | 108 | 68 | 51 | — | 13 | 13 | 11 | 10 |

### Example 4

The required power input in high shear treatment is studied in Example 4.

The samples used in Example 4 were 1) water as the reference, and 2) 0.2 weight-% solution of cationized starch CS 6, from Example 2.

For the measurement, the individual sample was placed in a 1 liter Dewar flask equipped with a thermometer and cork lid. The mixing head of IKA T25 digital Ultra Turrax® homogenizer with blade S 25 N-25 F was placed below the surface of the sample and the flask was closed tightly with the lid to avoid any heat losses. The high shear treatment was conducted in 4 minutes using 16000 rpm.

The shearing power was calculated using Equation 1:

$$P = \frac{{C}_{p} * ( {T}_{final} - {T}_{initial} )}{{t}_{T r e a t m e n t}} \qquad ( 1 )$$

where
P is Specific power, W/kg
Cₚ is Specific heat capacity, J/(° C.*kg)
Tᵢ is Temperature of the mixture, ° C.
t_{Treatment} is Time of the treatment, s

It was assumed that the sample mixture had a specific heat capacity of water.

The numerical (measurement) values used in calculation of the shearing power are shown in Table 7.

TABLE 7
Values used for calculation of the specific power requirement.

| | Water | CS 6 |
|---|---|---|
| Sample mass, g | 445 | 454 |
| Treatment time, s | 240 | 240 |
| Initial temperature, °C | 30.9 | 24.0 |
| Final temperature, °C | 32.9 | 36.0 |
| Temperature increase, °C | 2 | 12 |
| Specific power, W/kg | 35 | 209 |

The required specific power for high shear treatment was 209 W/kg solution.

Depending on equipment in use, rotation or pumping speed, treatment time, sample properties and sample concentration the power requirement may also be lower or higher. The sufficient conditions are defined by the increase in charge density of the treated sample and in improvement in its dewatering performance.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A method for flocculating solid particles in a liquid-solid separation process, the method comprising:
obtaining a flocculant solution comprising cationized starch having an original charge density <3 meq/g;
subjecting the flocculant solution to a high shear treatment;
after the high shear treatment, bringing the flocculant solution into a contact with a suspension of solid particles suspended in a continuous aqueous phase and flocculating the solid particles; and
separating the flocculated solid particles from the continuous aqueous phase in a dewatering step.

2. The method according to claim 1, wherein the flocculant solution is subjected in the high shear treatment to the shear power which is in a range of 5-1000 W/kg, preferably 20-500 W/kg, more preferably 35-209 W/kg, wherein preferably the duration of the high shear treatment is 1-600 s, preferably of 5-300 s, more preferably of 10-180 s.

3. The method according to claim 1, wherein the cationized starch has the original charge density in the range of 1.2-2.7 meq/g, preferably 1.5-2.5 meq/g, more preferably 1.6-2.0 meq/g, before the high shear treatment.

4. The method according to claim 1, wherein the cationized starch has a substitution degree in a range of 0.32-0.65, preferably 0.33-0.60, more preferably 0.34-0.55.

5. The method according to claim 1, wherein the flocculant solution comprises one or more cationic synthetic polymers, preferably cationic polyacrylamide.

6. The method according to claim 5, wherein the flocculant solution comprises 10-100 weight-%, preferably 30-100 weight-%, more preferably 50-100 weight-%, of cationized starch, calculated from the active polymer content of the flocculant solution.

7. The method according to claim 1, wherein the high shear treatment produces an increase in the charge density of the cationized starch which is 1.5-2.5 times of the original charge density.

8. The method according to claim 1, wherein the liquid-solid separation process is a treatment process of wastewater, preferably municipal wastewater or industrial wastewater.

9. The method according to claim 1, wherein the suspension has a biological oxygen demand (BOD)>50 mg/l, and/or a chemical oxygen demand (COD) in a range of 15-45 g/l, preferably 20-40 g/l, and/or a dry solids content in the range of 5-80 g/l, preferably 10-60 g/l, more preferably 20-55 g/l.

10. The method according to claim 1, wherein the flocculant solution is brought into the contact with the suspension in amount that provides of 1-30 kg of cationized starch/ton dry suspension, preferably 2-20 kg of cationized starch/ton dry suspension, more preferably 3-15 kg of cationized starch/ton dry suspension.

11. The method according to claim 1, wherein bringing an additional flocculating agent into contact with the suspension of solid particles separately from the flocculant solution comprising cationized starch.

12. The method according to claim 1, wherein the flocculant solution during the high shear treatment has a concentration of cationized starch in a range of 0.05-2 weight-%.

13. The method according to claim 1, wherein the flocculant solution is subjected to the high shear treatment in absence of oxidative agent(s).

14. The method according to claim 1, wherein the liquid-solid separation process is a sludge dewatering step of a water treatment process.
